(19) United States
(12) Patent Application Publication
(10) Pub. No.: US 2006/0161485 A1
(43) Pub. Date: Jul. 20, 2006

(54) Financial analysis tree software engine

(76) Inventor: Robert Allen Meldahl, Basking Ridge, NJ (US)

Correspondence Address: Robert Meldahl, 15 Hancock Court, Basking Ridge, NJ, 07920, US

(21) Appl. No.: 11/036,856

(22) Filed: Jan. 18, 2005

(51) Int. Cl. G06Q 40/00

(52) U.S. Cl. 705/35

(57) ABSTRACT

A Software Engine that summarizes the financial state of a business in a single hierarchical tree data structure. The root node of the tree is the balance equation of accounting, its leaf nodes are the ledger accounts of the company, and its internal nodes represent all of the sums required in preparing the balance sheet, the income statement, and the retained earnings statement. Each non-leaf node obtains its financial balance from its child nodes. Since the Income Summary and Retained Earnings are non-leaf nodes, they do not have to exist as separate ledger accounts and their respective child nodes do not need to have their balances closed and transferred to them—all accounts have a permanent (non-temporary) balance. The difference between two trees produces the income and earnings retention of the business.

### CROSS-REFERENCE TO RELATED APPLICATIONS

Not Applicable.

### FEDERALLY SPONSORED RESEARCH

Not Applicable.

### SEQUENCE LISTING OR PROGRAM

Not Applicable.

### BACKGROUND OF THE INVENTION

1. Field of Invention

The present invention relates to computer based accounting systems; and more particularly to a computer process that produces hierarchical tree data structures that contain all of the information found in the Balance Sheet, the Income Statement, and the Retained Earnings Statement.

2. Prior Art

Modern accounting practices, essentially developed in the Middle Ages, prepares financial statements by fragmenting the information accumulated during a fiscal accounting period and transferring balances from one account to another at the end of that fiscal period.

The financial transactions that have occurred to a business are recorded using what is called the “double-entry” bookkeeping system. In this system, various factors of the business are given categories that are referred to as “ledger accounts,” and each transaction causes at least one of these ledger accounts to be debited and at least one ledger account to be credited. Although more than one account can be debited or credited by a single transaction, the balancing nature of the accounting practice assures that total amount of the transaction's debits and the total amount of the transaction's credits will be the same.

Most of these ledger accounts keep a permanent balance that reflects the effects of all of the transactions that have either debited or credited the account since the beginning of the account recording process. These accounts are referred to as “permanent accounts.” Other accounts are known as “temporary accounts” because their balance reflects the effects of only those transactions that have occurred in the current fiscal period. At the end of the period, the balances of these temporary accounts are transferred to a permanent account, setting those balances to zero in preparation for the next fiscal period. This practice has the effect of fragmenting the information in the ledger accounts, rendering the balance of the temporary accounts relevant only for the current fiscal period and unable to be used with information from other fiscal periods or arbitrary “windows of time” in which the user may have an analytical interest. The balances of the permanent accounts that receive the balances of the temporary accounts are dependent upon the rigid schedule of the fiscal period reporting cycle and cannot be used to analyze the behavior of a business in a more general sense.

Originally, this fragmentation was necessary because of the lack of technology and the massive amounts of computations that had to be done by hand to prepare financial statements for a fiscal period. The temporary accounts (i.e. the revenue and expense accounts) needed to have a zero balance at the beginning of each fiscal period so that they would reflect the changes in revenue and expenses for the fiscal period. These changes in the revenue and expenses were used to calculate the income of the company and the easiest way of determining income was to have the balances of these temporary accounts only represent the income changes for a single fiscal period rather than a history of the company's income.

The necessity of keeping temporary balances for the fiscal period ended with the invention of modem computation machines, although the practice, maintained by tradition and professional inertia, has continued to the present. The practice may have been obviated long ago with the invention of the first mechanical adding machines; however, with the proliferation of the modem computer, its usefulness in making computations easier is definitely a thing of the past. Today, the practice of maintaining a separate account for a periodic balance no longer serves a useful purpose and only limits the analytical value of accounting information.

There have been some steps taken to eliminate the practice of closing temporary accounts and transferring their balances to income and retained earnings accounts, however, none of these steps have been as revolutionary as the present invention. Cisco Systems has used the concept of a “virtual closing” of the books within the fiscal period, using the computer to perform the arithmetic that is accomplished during the book closing process while keeping the temporary accounts intact. This has allowed them to generate financial information within the fiscal period before the books are actually closed for the more conventional financial statement preparation.

The practice of “virtual closings” has provided Cisco with some financial data before the fiscal period came to a close, but the present invention goes far beyond the “pretend closings” by eliminating the need for closing operations completely. The Income and Retained Earnings accounts that received the transferred balances from the temporary accounts are eliminated as ledger accounts completely and are made into internal nodes of a hierarchical tree. As internal nodes in a tree data structure, they actually compute their balances from their respective child nodes and these child nodes are actually the very revenue and expense accounts that are treated as temporary accounts in the traditional practice of accounting.

U.S. Pat. No. 6,813,611, to Louis Paul Herzberg and Charles Steven Lingafelt, entitled Controlling, configuring, storing, monitoring and maintaining accounting of bookkeeping information employing trees with nodes of embedded information, hereinafter referred to as the Herzberg invention, discloses a method and system for providing multilevel information about aspects of accounting. The method comprises the steps of generating a display, on a screen, of a tree having a plurality of nodes, and embedding in the nodes multilevel information about said accounting aspects. Each tree is able to display a single aspect and an aspect is considered to be one of a long list of terms, including debit, credit, assets, and revenues.

Although the Herzberg invention uses a tree to display financial information, including accounting information, it differs significantly from the present invention and would not make the present invention obvious in any way. Herzberg only uses a tree to display a single aspect of the accounting field. A tree that displays debits cannot display revenues, and a tree that displays revenues cannot display debits, credits, or expenses. In the present invention, each leaf node represents a ledger account and contains the critical information about that ledger account. Internal nodes represent summaries of a some of the ledger accounts, and specifically, there are, in the present invention, internal nodes that represent all of the assets of the company, all of the equities, all of the revenues of the company, all of the expenses of the company, all of the income of the company, and all of retained earnings of the company—simultaneously within the same tree. The present invention, differing greatly from the Herzberg invention, represents, in a single tree, the complete financial state of the company as of a specific point in time.

Another significant feature of the Herzberg invention is that is uses the tree concept only as a display device to present to the user information in a multilevel form. The present invention, on the other hand, uses the concept of an hierarchical tree as an internal data structure, an important component of the method and system that is the invention itself. The internal data structure in the form of an hierarchical tree is present to the user as a user interface tree, similar to the Herzberg tree, but it is also presented to the user as an XML file (XML files are, by definition, hierarchical trees), and it is also used in its tree form within the program without any presentation to the user. The present invention actually internally includes an abstract algebra of trees, allowing the program to perform operations on one or more of the trees to produce new trees.

While the Herzberg invention discloses a presentation device for displaying multilevel information of various kinds, the present invention discloses a method and system for representing the financial state of a business in an abstract data structure. The present inventions, definition of a financial state is exactly the same as that of the traditional accounting practice. The balance of all of the ledger accounts, the income summary, retained earnings, assets, equities, and the complete accounting equation are represented in a single tree of the current invention. All of the information found in the traditional Balance Sheet is found in a single tree data structure of the current invention. Furthermore, with the present invention, all of the information in the Income Statement and the Retained Earnings Statement can be produced using the present invention's concept of an abstract algebra of trees. By subtracting one tree, representing an earlier date, from a second tree, representing a later date, the present invention is able to produce a tree which represents the difference between the two financial states—including the income and earnings retention that has occurred between the dates of the two trees. Unlike Herzberg, or any other invention in the area of accounting, a hierarchical tree data structure represents all of the information found in the primary financial statements of the accounting industry.

U.S. Pat. No. 5,917,492, to Thomas William Bereiter and Doran Gan, entitled Method and system for displaying an expandable tree structure in a data processing system graphical user interface, hereinafter referred to as the Bereiter invention, discloses a method and system for displaying a graphical representation on a display screen of a data processing system in a manner that optimizes screen “real estate” and ease of information viewing. Although the present invention often displays the tree structure of its data in a manner similar to Bereiter, it does not use the technology of Bereiter. The present invention structures the financial state of a company into an abstract tree form (not having any specific user interface) and then expresses this tree structure in many ways, perhaps including in a way similar to Bereiter. But, these expressions of the abstract data tree are optional and varied. In fact, the most common expression of the present invention's data tree is in XML where they are typically reformatted into a specific user interface. Unlike Bereiter, which is discloses an expression, the present invention is disclosing an idea—an idea that can be expressed in many forms.

U.S. Pat. No. 4,642,767, to Moisey Lerner, entitled Bookkeeping and Accounting System, hereinafter referred to as the Lerner invention, discloses a method for providing bookkeeping and accounting as a running total. The accounts are given starting balances which are equal to the ending balances from the day before. Then, as each transaction occurs, its value is added to the starting totals of the appropriate accounts and a running total is kept for each account in the system and financial statements are then processed from the running totals at the end of the day. Like the present invention the Lerner invention allows a company to obtain a financial state of the company that is current to the present date. Unlike the present invention, Lerner does not allow the user to determine the financial state of the company for any arbitrary date that he wants. Only the current date is served by Lerner.

Lerner also does not find sophisticated roll-ups of account balances, such as the income and retained earnings, because it does not provide for the daily closing transactions (or their equivalent) that would be required to produce Income Statements and Retained Earnings Statements. The present invention, however, obviates the need for closing transactions—the measures of income and earnings retention is produced by the automatic operation of the Financial Analysis Tree Software Engine and the shape of the trees that it produces. The current invention produces the information that Lerner does but, unlike Lerner, produces the additional information that can only be done by closing the books (as in the traditional model of accounting) or have tree nodes that have derived income and earnings retention information in them (as the present invention does). Lerner does not produce the complete financial state of the company—the present invention does.

The present invention is a very innovative and elegant solution to a basic problem of accounting; the current invention, for the first time, frees the practice of accounting from its rigid dependence upon a fiscal period reporting cycle and it does this while preserving the ability to satisfy all of the requirements of the fiscal period reporting cycle. There remains a need in the art for an elegant way of summarizing the financial state of a business without altering the historical record (i.e. the closing of the temporary accounts) of the company's financial transactions

### OBJECTS AND ADVANTAGES

Accordingly, besides the objects and advantages of the Financial Analysis Trees described in this patent application, several objects and advantages of the present invention are:
a) The hierarchical tree data structure that is produced contains all of the information found in a classified balance sheet.
b) The data is produced for the user in a hierarchical tree that allows the user to “drill-down” to the level of detail that he is interested in, providing the user with both a summary balance sheet and a classified balance sheet.
c) In addition to the information found in a classified balance sheet, the tree contains information about the balances of each individual ledger account, allowing the user to “drill down” to the lowest level of detail available in accounting.
d) In addition, the tree contains income, revenue, and expense information that are not normally found in a balance sheet. Normally, this information is rolled up into the Retained Earnings account on the balance sheet. But, with the current invention, the retained earnings balance is not found in a separate ledger account; it is found in a parent node of the hierarchical tree and it derives its balance from its descendent nodes (i.e. the various revenue and expense accounts).
e) A tree can be produced for any point in time that the user is interested in. Using typical database procedures, each ledger account can find its balance as of the date that the user is interested in, and, once the ledger accounts, represented by the leaf nodes of the tree, have determined their respective balances, the computation ripples up the tree as each parent node determines its balance from the balances of its children nodes. The rippling up the tree continues until the ultimate root node of the tree is reached (the root nodes balance should always be zero).
f) A Financial State Tree can be used in combination with another Financial State Tree in an arithmetic operation to create a resulting third tree with the same structure but whose nodes contain values that are the result of the arithmetic operation between the corresponding nodes in the original trees (the trees have what is referred to as an algebra in abstract mathematics). For example, a tree prepared for Jan. 31, 2003 can be subtracted from a tree prepared for Mar. 31, 2004, resulting in a “difference tree” that reflects the changes in the company's financial state for the first quarter of calendar year 2004. Each node of the difference tree would reflect the change in that category of the company's business during that period (i.e. the “Utilities Expense” node would reflect the utilities paid during that period and the Income Summary node would reflect the quarter's income).
g) The trees involved in an arithmetic subtraction operation contain all of the information found in the Retained Earnings Statement. Looking at the Retained Earnings node of each tree, we see the state of the retained earnings at the beginning of the period between the dates of the two original trees, the state of the retained earnings at the end of that period, and the changes that occurred to the retained earnings during that period. In addition, the user can drill-down to the descendants of the Retained Earnings nodes and see how the individual revenue, expense, and distribution accounts changed their states during the period.
h) The trees in an arithmetic subtraction operation contain all of the information found in the Income Statement that is so important to accounting and the investment community. Looking at the Income Summary node of each tree, we see the state of the income at the beginning of the period between the dates of the original tree, the state of the income at the end of that period, and the changes that occurred to the state of the income during the period. As in the case of the Retained Earnings nodes, the user can drill-down to the descendents of the Income Summary nodes in each tree to obtain the details of the financial categories that make up the Income Summary node.
i) Using Financial State Trees and the arithmetic subtraction operation, the information for the Balance Sheet, the Income Statement, and the Retained Earnings Statement can be produced for any arbitrary time period that the user is interested in. The company's financial behavior can be analyzed for any week, month, or duration of time that is of interest of the analyst.
j) The most significant advantage of the present invention is that the accounts never have to be closed. The Income Summary and Retained Earnings nodes of the tree are internal nodes, meaning that they do not obtain their balances directly from transactions, but instead, obtain their balanced from the balances of their respective descendent nodes (i.e. the nodes that represent the various revenue and expenses ledger accounts). The accounts that contribute these balances to the Income Summary and Retained Earnings nodes do not have to have their balances actually transferred to a separate Retained Earnings account by way of a closing transaction. The arithmetic of “closing the books” is simply performed by the natural operations of the tree. The revenue and expense accounts remain intact and are able to contribute to the analysis of other times and periods other than that of the company's official fiscal period.

### SUMMARY OF THE INVENTION

In accordance with the present invention, all of the information normally found in a Balance Sheet, an Income Statement, and a Retained Earnings Statement can be incorporated into data structures in the form of hierarchical trees by using a computer process that obtains the balances of the ledger accounts and constructs the tree structures and performs elementary arithmetic on the trees. Each tree represents the complete financial state of a business at a certain point in time specified by the user.

The present invention is made up of three components;

A hierarchical tree data structure, known as a Financial State Tree, that represents the financial state of a business at a specific point in time (the user specifies the date of the tree),

A hierarchical tree data structure, known as a Financial Difference Tree, that has the same structure as the Financial State Tree, but represents the difference between two Financial State Trees—each node of the Financial Difference Tree has a balance that is the difference between the corresponding nodes of the Financial State Trees (Financial State Trees and Financial Difference Trees are referred, in general, as Financial Analysis Trees), and

A software engine, the Financial Analysis Tree Software Engine, referred to hereafter as the “Engine” or “Software Engine,” that creates and manipulates one or more of the Financial State Trees and creates Financial Difference Trees from existing Financial State Trees.

The Software Engine receives a data from the user and then generates a tree based upon the financial state of the business as of that date. The Tree's primary representation is as an XML format (an XML document is, by definition, a hierarchical tree structure of data), however a user interface will typically display it to the user in a tree format such as that found in the Windows Explorer in its representation of files and directories.

The Software Engine also accepts from the user two already created Financial State Trees, representing the financial state of a business at two different points of time, and from them produces a Difference Tree that reflects the difference between the two input trees (since the input trees represent the same business at different points of time, their differences represent difference in the company's state, including the company's income, earnings, and other critical information).

The present invention constructs a Financial State Tree from the financial balances in the ledger accounts. Each ledger account is treated as a “leaf” node in the tree—a terminal node without further branching below it. The current invention passes the balance of each of these leaf nodes to its immediate parent node. It then computes the balance of each parent node from the balances of its children and passes these new balances up to the next level of parent nodes. This process continues until the root node of the entire tree is reached, at which point, a complete Financial State Tree is complete, providing the user with all of the information normally found in the Balance Sheet, but also with the summaries of the company's income and retained earnings (as “permanent” rather than “temporary” balances). This represents the complete financial state of the business as of a given date specified by the user.

The internal nodes of the tree (the non-leaf nodes) represent the various summaries of financial information that are derived from the ledger account balances to create the important financial statements of accounting as well as most of the ratios that are used in ratio analysis. The balances of these internal nodes provide the data that is used to prepare Balance Sheets, Income Statements, and Retained Earnings Statements (actually, the Income Statement and the Retained Earnings Statement are completed by combining the information in two of these Financial State Trees, one tree representing the financial state of the business at the beginning of an arbitrary period and one tree representing the financial state of the business as the end of that period).

Ratio analysis, such as the Current Ratio, is accomplished by taking the balance of one set of ledger accounts (i.e. Current Assets) and comparing that balance to the balance of another set of ledger accounts (i.e. Current Liabilities). These categories of ledger accounts are typically represented by the internal nodes of the Financial State Tree.

Internal nodes that are of particular importance are the Income Summary node and the Retained Earnings node. There are the nodes that are used to generate the Income Statement and the Retained Earnings Statement. More importantly, these are the nodes that summarize the so-called “temporary accounts” in the traditional model of accounting. Since they are internal nodes, they are not ledger accounts in their own right (all ledger accounts are leaf nodes—they cannot have children nodes and they therefore do not receive their balance from other nodes). The balances in the Income Summary and Retained Earnings nodes are not obtained from destructive closing transactions, as is the case in the traditional model of accounting; they are derived from the computations that are performed by the present invention that derives the balance of each internal node from the balances of its children nodes.

The critical importance of the Income Summary and Retained Earnings nodes is that they very elegantly render unnecessary the closing transactions of traditional accounting. The Income Summary node is the ancestor of the revenue and expense account leaf nodes and its balance is the arithmetic combination of those accounts (the balances in the revenue and expenses leaf nodes are “permanent” balances). In the traditional accounting model, the expense accounts and revenue accounts are temporary accounts that have their balances set to zero by closing transactions that transfer their balances to the separate Income Summary account. In the present invention, the arithmetic operations that ripple up the tree cause the balances of these temporary accounts to be used to find the balance of the Income Summary internal node; there are no transfers of balance from one account to another and the revenue and expense accounts remain intact, ready to be used with another analysis for another period of time.

If we look at the actual tree in FIG. 1, we see that the various expense ledger accounts are actually the immediate children of the “Expenses” internal node. The balance of the Expenses node is the sum of the balances of all of the expense ledger accounts. Similarly, all of the revenue ledger accounts are the immediate children of the “Revenue” internal node, and the balance of this Revenue node is the sum of all of its children nodes (i.e. revenue accounts). The total revenue and the total expenses exist as nodes in the tree and are generally presented to the user as a part of the tree that is generated for him.

Proceeding further up the tree in FIG. 1, we see that the Revenue and Expenses nodes are the children of the “Income Summary” node, and, the present invention determines the balance of this Income Summary node by arithmetically combining the balances of the Revenue and Expenses nodes. This is analogous to what is accomplished by the closing transactions of the traditional model of accounting, and it produces the same result; however, this result does not alter the ledger accounts and leaves them available for other analysis.

Again proceeding up the tree in FIG. 1, we see the Income Summary node is a child of the “Retained Earnings” node. As a child node, the Income Summary node provides its balance to its parent, the Retained Earnings node. The other child node of the Retained Earnings node is the “Distributions” node that is the sum of all of the dividends and other distributions made by the company to its equity holders. This is just as it should be; exactly as in the case of the traditional model of accounting, the Retained Earnings is the arithmetic combination of the company's income and its distributions (the distributions actually reduce the income in determining the Retained Earnings). The present invention accomplished the exact same determination of the company's retained earnings, but again, it does it without disturbing the transactional history of the business.

It is important to note here that, since the revenue, expense, and distribution accounts are not closed, their balances reflect the complete record of all the true financial transactions that have affected them in the history of the business. In short, they are now permanent accounts and their data is not just a summary of the current quarter's activity. In a similar manner, the Income Summary is not the income for the current quarter (we will see how this is provided by the present invention shortly, however). The Income Summary's balance is a permanent balance—in effect, a record of the company's total income from its inception (or, more likely, sine the last closing under the traditional accounting model. The Income Summary node is a permanent node, analogous to a permanent account—it is the arithmetic sum of the now permanent revenue and expense accounts. How the user of the present invention determines the income for a particular period of time from the permanent Income Summary node will become obvious as we continue.

The Retained Earnings account in the traditional model of accounting, unlike the Income Summary account in that model, is a permanent account. Its balance is intended to reflect the total accumulation of earnings that are retained in the company's history, and, for this reason, the balance of the Retained Earnings node in the present invention is exactly the same as that of the Retained Earnings account in the traditional model of accounting. A major difference between the present invention and the traditional model is that all of the nodes in the present invention have permanent (non-transferable) balances. All accounts that are permanent in the traditional model will have the same balance in the current invention. The differences of account balances that exist in the present invention exist only where the corresponding accounts in the traditional model are temporary. In the case of the traditional model's temporary accounts, the corresponding nodes in the present invention differ only by the maintenance of a permanent balance.

The permanent balances in the present invention are able to produce the same information in the temporary balances of the traditional model, satisfying the requirements of the accounting that originally led to the existence of temporary accounts, and, for this reason, the present invention is a valid substitute for the traditional model of accounting. The present invention has nothing but permanent balances that represent the financial state of the business at a certain point in time, but from these permanent balances, the present invention is able to produce the same temporary information that goes into the Income Statement and the Retained Earnings Statement in the traditional model.

The “temporary” information produced by the traditional model of accounting represents the differences that have occurred to the company's financial state during a given fiscal period. Because of its temporary status, the balance in a given revenue account in the traditional accounting model represents the amount of revenue generated between two points in time, typically between the beginning of the current fiscal period and the present time. It represents the change in the account between two periods of time. While the balance of a permanent account represents the total amount of changes that have happened to that financial category since the beginning of the business, the balance of a traditional temporary account represents only those changes that have happened between one point of time (i.e. the beginning of the fiscal period) and a second point of time (i.e. the end of the fiscal period). Temporary accounts simply represent the difference to a financial category between two points in time.

This same difference between two points in time can be easily produced by the present invention. Each Financial State Tree represents a single point in time in the financial history of the business. By producing two of these trees, representing two different points in time, and subtracting the balances in the later tree from the earlier, the present invention produces the changes that have occurred to the business between the two points in time. In particular, the difference between the Income Summary nodes in the two trees gives us the amount of income that was produced in the period between our two points of time. This is enough to complete the Income Statement for the period. Similarly, the difference between the Retained Earnings nodes in the two trees gives us the information needed to complete a Retained Earnings Statement for the period of time designated by our two trees.

The information produced by subtracting one tree from another far exceeds that produced by the financial statements of the traditional model of accounting. Not only is it able to produce the same information as the Balance Sheet, the Income Statement, and the Retained Earnings Statement, but it also gives us a more specific record of all of the changes in all of the business categories (that is, ledger accounts) for the period. We are able to see the changes that have occurred to all of the revenue and expense accounts (this information is typically lost in the traditional model when the balances are closed). We are even able to see the quarterly changes in all of the permanent accounts as if they were temporary accounts. The result of subtracting the balances of one tree against those of another produce far more information than the traditional financial statements and, because the present invention does it without closing the books, the user is free to create more trees from the data and analyze more differences between trees representing arbitrary points of time—the analytical advantage of using the present invention to producing trees and observing the differences between them is immense.

The present invention includes a very elegant way of finding the differences between two Financial State Trees and presenting these differences to the user. When the present invention is asked to take the difference between two Financial State Trees, it traverses each tree and takes the difference of the corresponding nodes from each tree, resulting in a third tree, a Financial Difference Tree, that has the same nodes as the two Financial State Trees but the balances of whose nodes is the difference between the balances of the corresponding nodes in the two Financial Difference Trees. This node-by-node arithmetic is illustrated in FIG. 3 of the present application.

For example, given one Financial State Tree, representing the financial state of the company as of Dec. 31, 2003, and a second Financial State Tree, representing the financial state of the company as of Mar. 31, 2004, the present invention can produce the Financial Difference Tree that reflects the changes in the company for the fiscal period between the date represented by the original two trees (this example would be for the fiscal period that is the first quarter of the calendar year of 2004). The invention is able to generate these trees, for any arbitrary date of the user's choosing, upon his request. Each node of the Financial Difference Tree provides the user with the change in the corresponding nodes of the original trees. The leaf node that represents the Cash account will show the change in the Cash account for that period and the Assets internal node will reflect the change in the company's assets during that period. In particular, the Income Summary node will show the company's income for that quarter and the Retained Earnings node will show the company's retention of earnings for the fiscal period—together, the two Financial State Trees and the resulting Financial Difference Tree contain the information found in the standard Income Statement and Retained Earnings Statement.

In summary, the present invention produces two tree data structures that each represent the financial state of the business at arbitrary points in time and then it enables the user to find the changes in the company's financial state between these two points in time by producing a Financial Difference Tree. The Financial Difference Tree shows the changes to all of the company's financial categories for the duration of time that exists between the two original trees.

The present invention produces all of the information found in the traditional combination of the Balance Sheet, the Income Statement, and the Retained Earnings Statement, and these financial statements are easily produced from the trees of the present invention. In addition to this, it provides details that could never be found in those standard financial reports; it provides the user with the ability to drill-down to see the beginning, ending, and the amount of change that has occurred to any ledger account or other financial category during the time period that the user is analyzing.

Most importantly is the fact that the present invention allows the user to use time arbitrarily whereas the traditional model of accounting forces the user to use only the company's formal fiscal period in his data analysis. With the present invention, the user can be provided with the information in the basic financial statements for any time period that he chooses. He can repeat his analysis for arbitrary periods that overlap with each other and for periods of the length of a quarter, month, week, or any duration that the user is interested in. With the traditional model, the user is issued a set of financial statements for a rigidly scheduled single period (typically, a quarter). In the traditional model, the user is unable to drill-down to periods of smaller duration to view the changes in greater detail. It is this flexibility of time that makes the present invention a true revolution in financial analysis.

### BRIEF DESCRIPTION OF DRAWINGS

FIG. 1 illustrates the typical implementation of the Financial State Tree data structure. Each rectangle in the figure is a node where data is summed from the nodes directly below it in the tree. The circles are leaf nodes that represent ledger accounts. These leaf nodes obtain their balances from a ledger account that they represent (or their equivalent of a ledger account).

FIG. 2 shows how a single internal node is able to generate its balance from the balance of its children nodes. The Engine determines the balance of each child node and then adds that balance to the balance of the parent node.

FIG. 3 shows how arithmetic can be performed between two Financial State Trees, generating a third resulting Financial State Tree (For clarity, only two internal nodes of each tree are illustrated). In this case, the Engine subtracts the balance of one tree, representing the financial state of a business at a certain point in time, from another tree, representing the financial state of the business at a later point in time. The resulting Financial Difference Tree contains all of the changes in accounts that have occurred between the two points of time. More specifically, it contains the summary of the company's income and change in retained earnings for the period of time between the two specific points of time represented by the first two trees. The Financial Difference Tree contains all of the information found in the principle financial statements of accounting—the Balance Sheet, the Income Statement, and the Retained Earnings Statement (of course, it contains much more than this).

FIG. 4 is an XML application that is an actual embodiment of a tree or a given (hypothetical) business.

FIG. 5 is a flowchart that shows how the Software Engine produces a Financial State Tree from the user's XML specifications as to how the ledger accounts should be organized under internal nodes in a tree. From the user's specifications, the Software Engine constructs the internal nodes without balances and then obtains the identity of the leaf node ledger accounts. For each leaf node encountered, the Software Engine calls the Account Balance Module that produces the corresponding ledger account's balances as of the date of the tree. Once the leaf nodes have their balances determined, the Software Engine returns up the tree, computing each internal node's balances from the balances of its children nodes. This process terminates upon reaching the root of the tree at a point when the complete financial state of the business is filly computed. The following reference points are indicated in the diagram:

501. the user begins the process by making a request for the company's financial state as of Dec. 31, 2004;

502. the software engine reads in an XML file that gives the user's specifications on how the tree should be constructed;

503. the software engine creates a child of the root node by calling the recursive “CreateChild” subroutine (at 505) that continues to create children for each level of the tree; this continues for each child node of the root node;

504. the Financial State Tree is complete in XML and ready to be presented to the user;

505. the recursive CreateChild subroutine begins;

506. if the child node being created by this call to CreateChild is a leaf node, the subroutine creates the leaf node and then goes to the Account Balance Module to obtain the balances of the leaf node's corresponding ledger account;

507. if the child node being created by this call to CreateChild is an internal node (not a leaf node), the subroutine creates the internal node and then, for each child node of the new internal node, it calls CreateChild again to create the internal nodes children at the next level;

508. the recursive call to CreateChild is made for the next level; this process continues until leaf nodes are reached;

509. after all of the next level of children are created, the current internal node is able to determine its own balance by adding the balances of its children;

FIG. 6 is a flowchart that shows how the Software Engine subtracts one Financial State Trees from another to produce a Financial Difference Tree. The Financial Difference Tree summarizes the changes that have occurred to the business in the duration of time between the date of the first Financial State Tree and the second, including the amount of income and earnings for that period. The following reference points are indicated in the diagram:

601. the user begins the process by selecting two Financial State Trees of different dates;

602. the difference between the root nodes of the later and earlier Financial State Trees determines the values of the node being produced for the Financial Difference Tree;

603. the recursive “ComputeChild” subroutine is called for each child of the root node;

604. a complete Financial Difference Tree is expressed in XML and returned to the user;

605. the ComputeChild subroutine begins;

606. the difference is found for the particular child node;

607. the recursive ComputeChild subroutine is called again for the next level of child nodes;

608. the ComputeChild subroutine is completed and returns back up one layer in the new Financial Difference Tree;

FIG. 7 is typical user interface of a Financial State Tree. It shows it as a hierarchical tree in the manner that the Windows Explorer shows the hierarchy of directories and files in its file system (many other programs use this same user interface device to illustrate hierarchical relationships). This is one of the presentations of the tree that can be made to the user. The present invention typically produces the tree in a presentation neutral XML format and the many user interfaces that can be used convert the XML to some illustrative form. FIG. 7 probably represents the most visually appealing expression of the tree. Note at points 701 and 702 of the figure, the debit balance of the Assets node is equal to the credit balance of the Equities node and the credit balance of the Assets node is equal to the debit balance of the Equities node—effectively, a proper expression of the Accounting Equation.

### DETAILED DESCRIPTION OF PREFERRED EMBODIMENTS

The preferred embodiment of the present invention is made up of three components; a hierarchical tree data structure, known as a Financial State Tree, that models the financial state of a business at a specific point in time, a second hierarchical tree data structure, known as a Financial Difference Tree, that models the change between two Financial State Trees, and a software engine, the Financial Analysis Tree Engine (“Engine”), that creates and manipulates one or more of these Financial State Trees and Financial Difference Trees based upon user input.

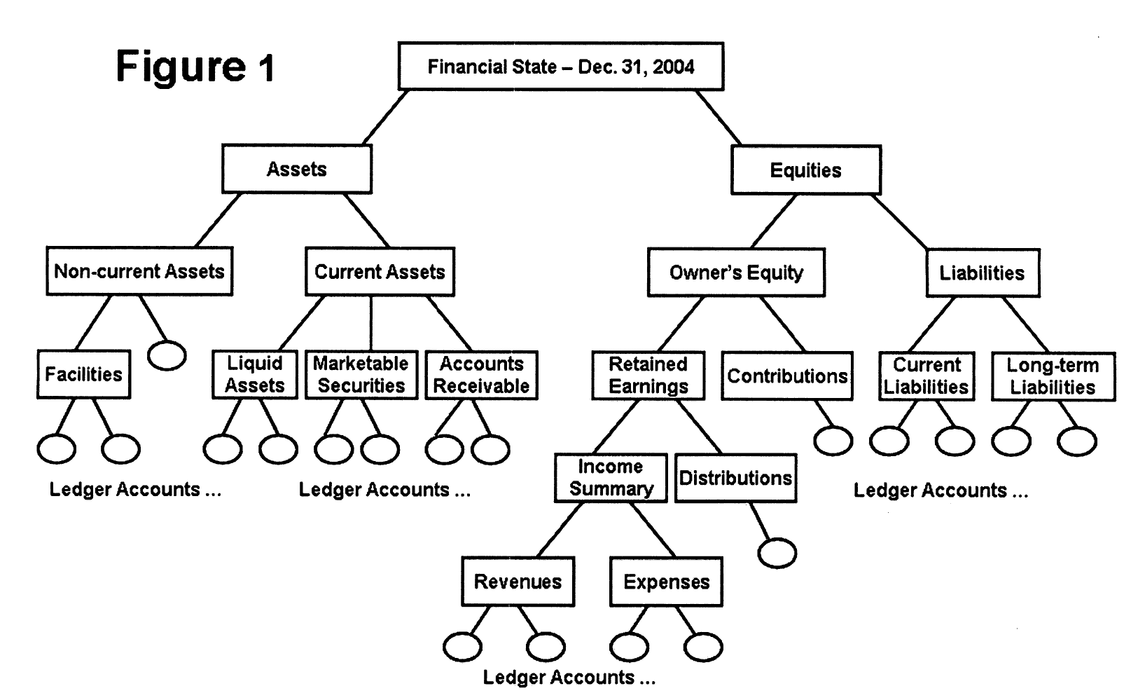

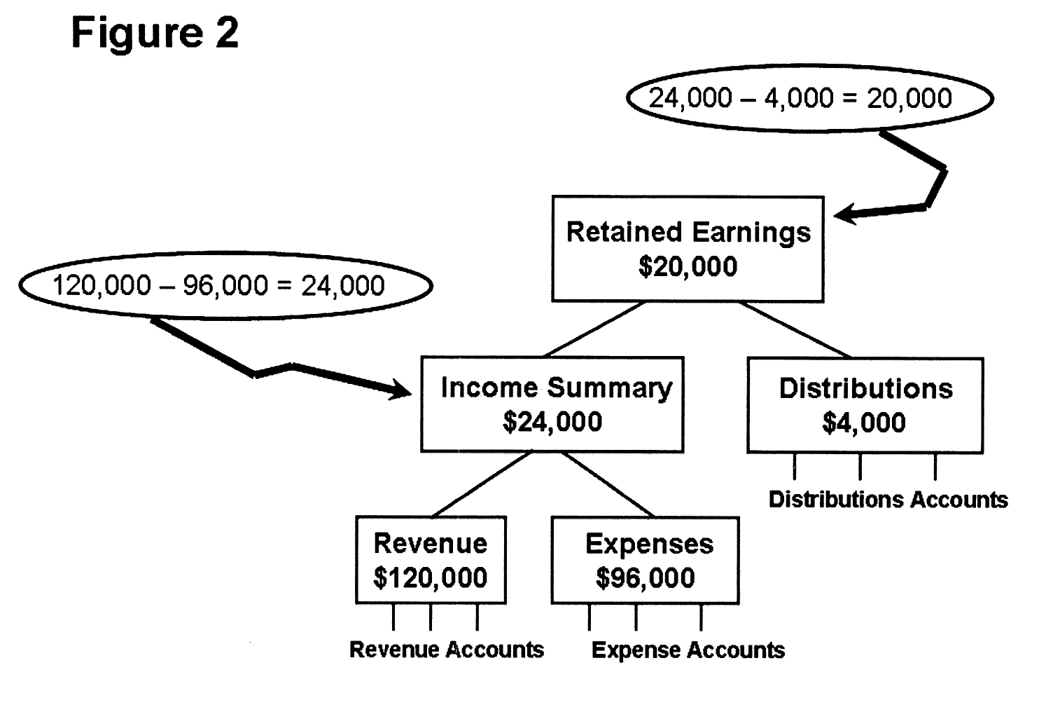

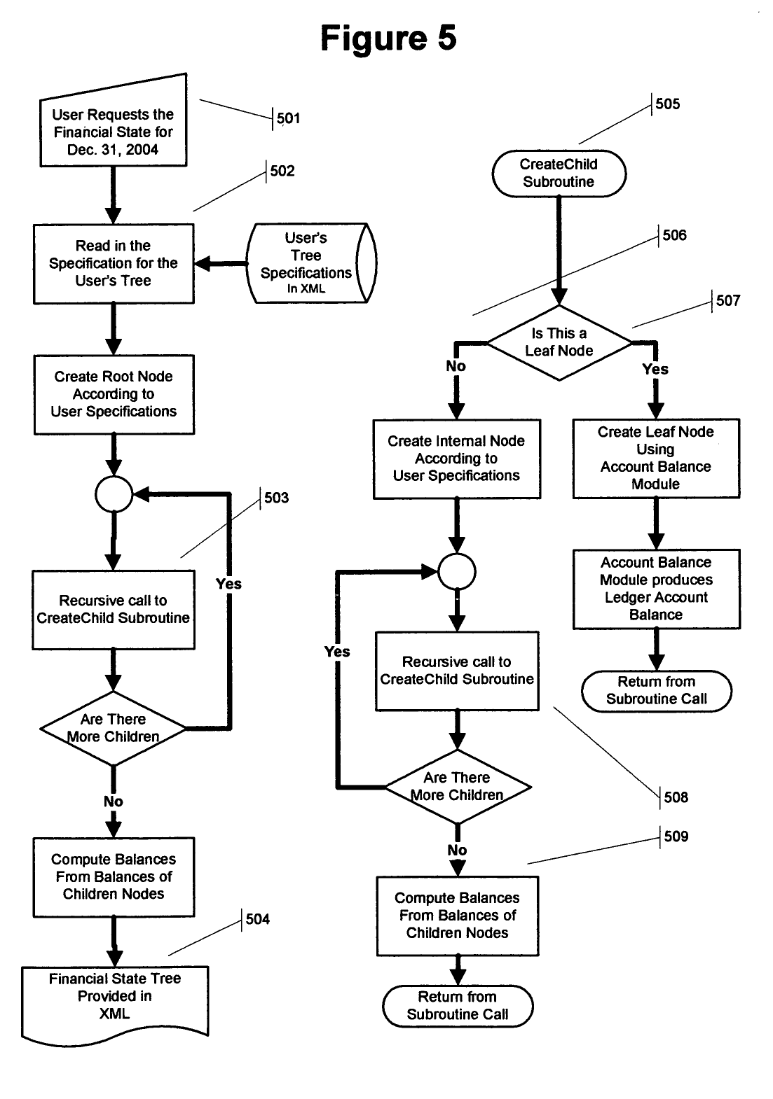

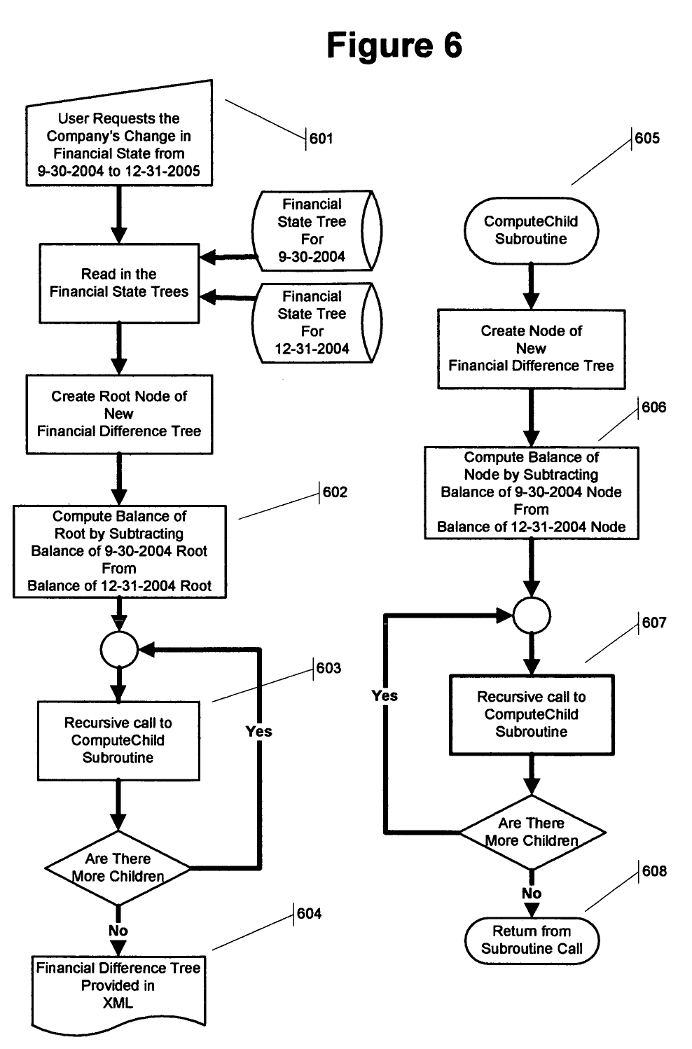

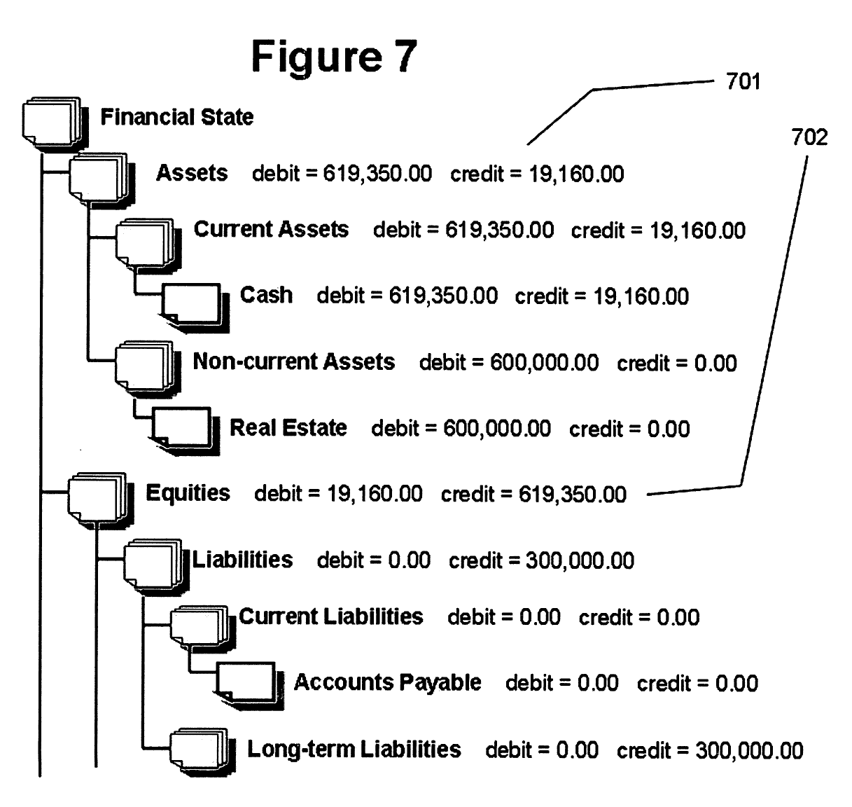

A preferred embodiment of the Financial State Tree is illustrated in FIG. 1 and the preferred embodiment of the Financial Analysis Tree Engine is shown as flowcharts in FIGS. 5 and 6. FIG. 1 is a data diagram that shows the relationship between the different components of the trees, FIG. 5 is a flowchart that shows how the present invention constructs a tree after receiving a request (with an effective date) by the user, and FIG. 6 is a flowchart that shows how the present invention takes two Financial State Trees and produces from them a third tree, a Financial Difference Tree, that shows the changes that have occurred in the company's financial state between the times of the two Financial State Trees. Each Financial State Tree is created for a specific point in time in the company's history and the difference between two trees, representing two difference points in time, reflects financial change, including the company's income and changes to retained earnings.

The hierarchical tree shown in FIG. 1 is only a typical structure, with some parts of the structure varying depending upon the specific financial need of the particular business and industry. There are parts of the structure that are necessary and required and there are other parts of the tree that represent the specific needs of the user's business. In FIG. 5, it is shown that the engine reads in an XML file that defines the true structure that the particular business wants to use to summarize its financial state.

The variability that can exist between Financial State Trees that represent different businesses must follow a set of requirements that define the invariant parts of the tree as well as the parts that can be tailored for the specific company. For example, the leaf nodes of the tree must include all of the ledger accounts that the company uses. This complete coverage of the ledger accounts is invariant; however, these ledger accounts can be different for each company and the way that these ledger accounts can be categorized by parent nodes in the final model of the Financial State Tree is largely optional and variable to meet the needs of the specific company.

Some parts of the of the company's tree structure are absolutely necessary in order to satisfy the requirements of the standard financial statements that are so important to accounting. The Financial State Tree for a particular business must be structured in such a manner as to produce the information found in the standard Balance Sheet. In addition, it must be structured in such a manner that, when it is combined with a tree of the same structure for a different date, it can produce the amount of “change” information that is found in the traditional Income and Retained Earnings statements.

In order to meet the information standards of the traditional Income Statement, all of the expense and revenue accounts need to be descendants of the “Income Summary” node of the tree. There can be any number of generations of internal (parent) nodes between the Income Summary node and the various accounts; however, the balance of those accounts must eventually contribute to the balance of the Income Summary node. It is also necessary that all of the ledger accounts that contribute to this Income Summary node must be revenue or expense accounts.

In a similar manner, in order to meet the informational standards of the traditional Retained Earnings Statement, the Income Summary node and the distribution ledger accounts (i.e. the “Dividends” account) need to be descendants of the Retained Earnings node and other ledger accounts should not contribute to that node. Again, there can be optional intervening generations of nodes between the Retained Earnings node and these requisite descendants, but, eventually, these descendants must contribute there balances to the balance of the Retained Earnings node. These requirements make the balance of the Retained Earnings node exactly what the balance would be in the Retained Earnings ledger account that is found in the traditional model of accounting.

Many of the other internal nodes found in FIG. 1 are optional and the user can add other internal nodes that help him categorize his financial state for optimal analysis. Many of the internal nodes shown in FIG. 1 can be used to support the ratio studies that are found in Financial Analysis. Of course, what are required are the following nodes:

The root node shown in FIG. 1;

The two immediate child nodes of the root node, the Assets node and the Equities node;

The two child nodes of the Equities node, dividing the Equities into Owner's Equity and Liabilities (creditor's equity);

The Retained Earnings node must exist as a descendant of the Owner's Equity node;

The Income Summary node must exist as a descendant of the Retained Earnings node;

All of the company's ledger accounts must be leaf nodes in the tree in such a manner that all of the asset accounts are descendants of the Assets node and all of the liability accounts are descendants of the Liability node;

All of the revenue and expense ledger accounts must be descendants of the Income Summary node;

And all of the distribution ledger accounts must be descendants of the Retained Earnings node.

Having distinguished the required structure of the Financial State Tree from its optional (user defined) structure, the need for the Engine of the present invention to read in the user's structure becomes obvious. The user's XML file specifies the internal nodes and the ledger accounts that are to be treated as leaf nodes in the tree. Most important, the XML file specifies the parent/child relationships between all of the nodes in the resulting tree.

Continuing in the flowchart of FIG. 5, we see that the Engine begins to construct a Financial State Tree for the date specified by the user in accordance with the user's particular tree specifications in the XML file. The algorithm that it uses is called a recursive algorithm. A recursive algorithm has logic in it to build a tree of unknown depth and breadth by starting at the top of the tree and completing each node by continuing down the tree and completing the node's children nodes. The Software Engine's algorithm begins by creating a root node and then creating its immediate children nodes. For each child nodes that it creates, the node's balance is left incomplete while the Engine continues to the next level of children nodes. This process goes on until a leaf node is reached, at which point, the algorithm no longer attempts to create children nodes, but rather, proceeds to obtain the balance for the leaf node.

The leaf node corresponds to a ledger account of traditional accounting, and the balance of a leaf node can be obtained from one of the various forms of computerized equivalent of the traditional accounting ledger. If the account is in a special table of a database, the accounts balance can be obtained with the use of a typical SQL statement. If the account is not in a standard SQL database, another method may be required. The flowchart shows the Software Engine calling an “Account Balance Module.” This module is really an implementation of what is referred as a “strategy design pattern.” Using the strategy design pattern, there may be many different implementations of the Account Balance Module, one for SQL databases and others for other methods of obtaining an account balance for a particular date. The particular version of the Account Balance Module that is used is part of the initial configuration of the Software Engine. The Engine is started up with the particular version of the Account Balance Module that is required for the particular user.

After the Software Engine has obtained the account balance for the leaf node, it returns to the leaf node's immediate parent and reports the leaf node's balance to that parent node. It then continues to complete that parent node by creating any other children nodes that it may have. When all of that parent node's children are completed (some may be leaf nodes and some may be internal nodes) and all of its children nodes have had their balance returned to the parent node. The Engine computes the balance of the parent node and reports that balance to its parent node.

This process of computing each node's balance from its children nodes and using that node's balance to compute its parent node's balance continues until the root node is reached, at which point the tree is complete and the root node's balance should be equal to zero. The nodes are created from the root down with their respective balances left undetermined. After the leaf nodes are reached, their balances are completed and the process of determining the balances of parent nodes continues back up the tree until the root node is reached.

A close examination of FIG. 1 shows that the Financial State Tree is primarily an elegant and advanced embodiment on the standard Balance Sheet that is the cornerstone of the financial reports of accounting. The Financial State Tree represents the financial state of the business as of a particular point in time (as does the Balance Sheet, although the standard Balance Sheet contains far less information).

The fact that a Financial State Tree is a complete substitute for the traditional Balance Sheet and a full representation of the company's financial state becomes increasingly important when we apply the principle that what we call change represents the difference between two states in time. In accounting, as in physics and other areas of science and business, the difference between the states of an object between two points in time reflects the change that has occurred to that object within the duration between those points in time. In science, the change in state could indicate how that object has increased in size and density as the temperature has increased across time. In biology, a plant's change might indicate its growth and maturation during a portion of a growing season. In accounting, the change in the company's financial state across time produces an immense amount of information, including the change in the company's revenues and expenses which, combined, we refer to as income.

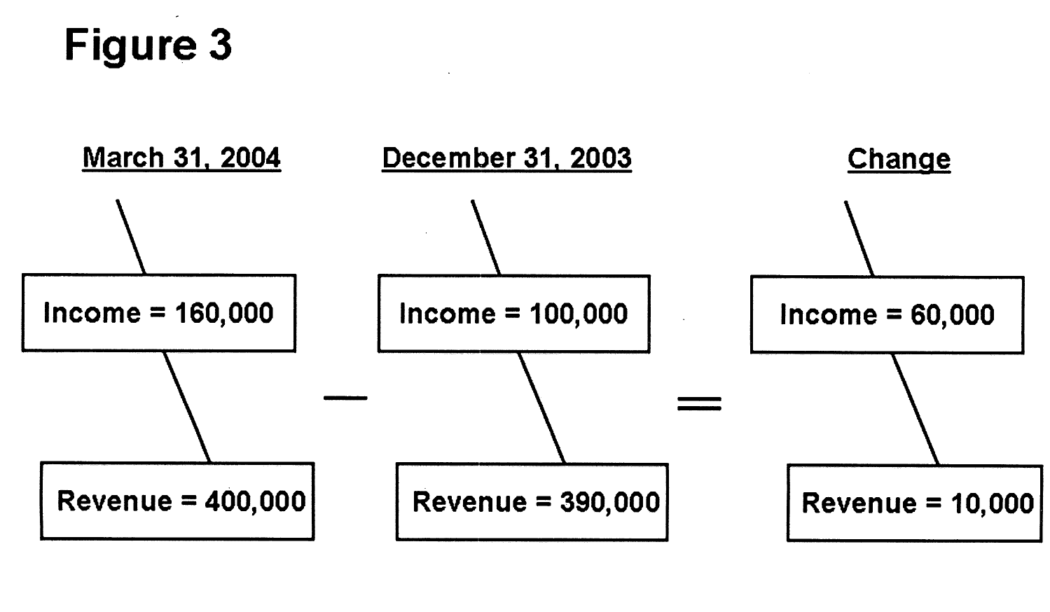

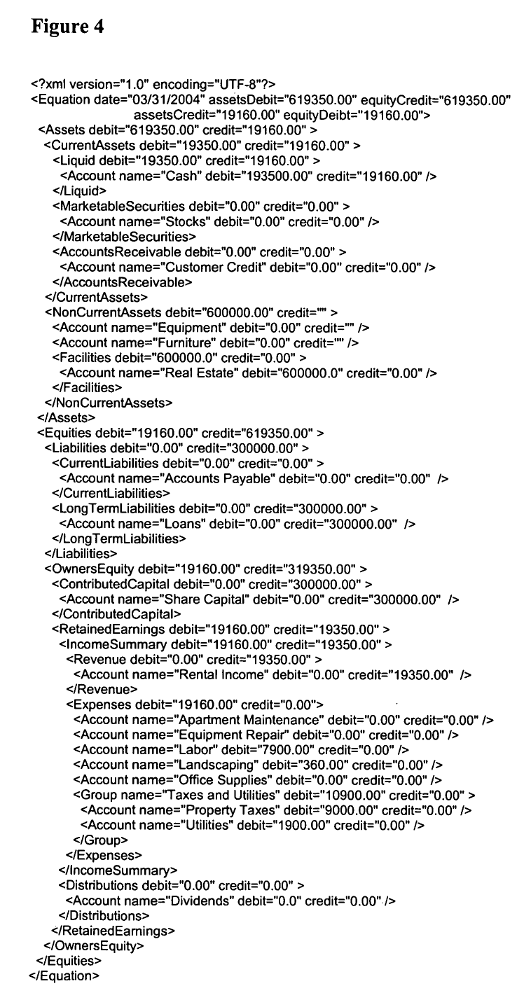

The present invention enables the user to generate one or more complete summaries of a company's financial state for arbitrary points in time. The present invention also enables the user to find the changes between any of these summaries of financial state by simply taking the difference between one Financial State Tree and another, producing in this operation a third tree known as a Financial Difference Tree, that has the same structure as the Financial State Trees (the same nodes in the same position in the tree), but whose nodes have balances that reflect the difference between the corresponding nodes in the Financial State Trees. The node-by-node arithmetic operation is shown in FIG. 3 where the company's income for a period of time is derived from the difference in the balance of the two nodes in the Financial State Trees. With this Difference Tree we can obtain all of the information found in the traditional Income Statement and Retained Earnings Statement (since it has the same information, we certainly have the ability to simply format the data into a traditional Income Statement or Retained Earnings Statement).

Of course, the important point isn't that the user is able to generate income and retained earnings information so easily; the important point is that the user is able to do this for any arbitrary duration of time. A physicist would not be able to determine the velocity of an object if he could only determine its position every fiscal quarter; a biologist would be unable to study the maturation of a plant if he could only test its state at the beginning and ending of the growing season; and a financial analyst is not able to analyze the behavior of a business if he can't break down the quarter's changes in revenue into months, weeks, and days.

The present invention enables the financial analyst to create Financial State Trees for arbitrary points of time, study the state of a company as of an exact moment, and then find the change in the company's state for any time duration that he is interested in.

FIG. 6 is a flowchart showing how the Software Engine creates a Difference Tree from two Financial State Trees. It follows a recursive algorithm similar to the one that generates the Financial State Tree itself. It first determines which of the two trees is for the earlier date, making that tree the subtrahend in the difference operation. It then starts from the root node of both trees and finds the difference between the balances of the two roots and creates the root for the Difference Tree, providing it with the difference between the balances of the roots of the two Financial State Trees.

Having resolved the root of the Difference Tree, the Engine proceeds down the two Financial State Trees, creating a node in the Difference Tree for each set of nodes that it finds in the Financial State Trees, and providing that node with a balance that is the different between the balances found in the two nodes of the Financial State Trees. This process continues through the leaf nodes and completes when all of the nodes of the Financial State Trees have been processed.

The Software Engine produces Financial State Trees that represent “snapshots” of the financial state of a business at a given point in time, and if finds the difference between two financial states represented by these snapshots, enabling the financial analyst for the first time in history to be able to truly investigate the financial behavior of a company.

From the description above, a number of advantages of the Financial Analysis Tree Software Engine become evident:
a) A single Financial State Tree contains more information than a conventional Balance Sheet. Should the user desire, an actual conventional Balance Sheet can be easily created from the values in the tree.
b) The arithmetic difference between two Financial State Trees produces all of the information found in a conventional Income Statement. A conventional Income Statement can be easily created from the value in the two Financial State Trees and the resulting Financial Difference Tree.
c) The arithmetic difference between two Financial State Trees produces all of the information found in a conventional Retained Earnings Statement. A conventional Retained Earnings Statement can be easily created from the value in the two Financial State Trees and the resulting Financial Difference Tree.
d) All of the information that accountants generate from the ledger accounts can be easily found in any two Financial State Trees and their differences without the need for a “closing of the books.” This obviating of the need for closing operations is extremely valuable because it allows the data in the ledger accounts to be used for other financial analysis that concerns different and even overlapping time periods. It effectively frees the practice of accounting from its dependence upon a single fiscal period cycle. In a conventional accounting system, data can only be computed concerning the official fiscal periods of the company, critically limiting the amount of information that can be derived from the accounting practice.

Having thus described the invention in rather full detail, it will be understood that such detail need not be strictly adhered to, but that additional changes and modifications may suggest themselves to one skilled in the art, all falling within the scope of this invention as defined by the subjoined claims.

What is claimed is:

1. A financial analysis tree software engine, hereinafter referred to as the engine, that generates financial information, comprising:
a. said engine creating and maintaining a hierarchical tree data structure, hereinafter referred to as a financial state tree, representing the financial state of an enterprise at a certain point in time;
b. said engine creating said financial state tree in such a manner that each leaf node of the said financial state tree represents a ledger account and its state as of a certain point in time;
c. said engine creating said financial state tree in such a manner that each node of said financial state tree has a debit balance and a credit balance, the leaf nodes of said financial state tree having the balances of the said ledger account that it represents as of the said point of time that said financial state tree represents, and the internal nodes of said financial state tree having a balance that is the arithmetic sum of the balances of its respective child nodes;
d. said engine creating said financial state tree in such a manner that the root node of said financial state tree represents the fundamental accounting equation and has only two children nodes, a node that represents the sum of all of the said enterprises equities and a node that represents the sum of all of the said enterprises assets;
e. said engine creating said financial state tree in such a manner that the said node of said financial state tree that represents the equities of the enterprise has two children, a node that represents the sum of all of the said enterprise's liabilities and a node that represents the sum of all of the said enterprise's owner's equity;
f. said engine creating said financial state tree in such a manner that the said node of said financial state tree that represents the owner's equity has a child internal node that represents the retained earnings of said enterprise;
g. said engine creating said financial state tree in such a manner that the said node of said financial state tree that represents the retained earnings has a child internal node that represents the income summary of said enterprise;
h. said engine creating said financial state tree in such a manner that the said node of said financial state tree that represents the income summary of the said enterprise shall have as its descendants all of the leaf nodes that represent the revenue and expense ledger accounts;
i. said engine creating said financial state tree in such a manner that all of the said leaf nodes in said financial state tree that represent revenue, expense, and distributions of the said enterprise have balances that represent the permanent balances of said ledger accounts—in effect, the balances that would be in those said ledger accounts if all closing transactions were excluded, leaving the balances of said revenue, expense, and distribution ledger accounts the summary of all of the non-closing transactions that have affected those said ledger accounts to the point in time that is represented by the tree instance;
j. said engine creating said financial state tree in such a manner that all of the said ledger accounts of the said enterprise, with the exception of the income summary and retained earnings account, must be represented as leaf nodes in said financial state tree;
k. said engine structuring said financial state tree according to the specific ledger accounts, categories and other groupings that best suit the particular enterprise, this variability being limited only be the other requirements set forth herein;
l. said engine creating and maintaining any number of said financial state trees, each instance of said financial state trees representing the financial state of the said enterprise as of a single point in time.

2. A financial analysis tree software engine as recited by claim 1, where said engine produces a traditional accounting balance sheet from the financial state tree that it has created as recited by claim 1.

3. A financial analysis tree software engine as recited by claim 1, where said engine produces a hierarchical tree data structure, referred to hereinafter as a financial difference tree, from two financial state trees that it has created as recited by claim 1, each of the two said financial state trees representing a different point in time, the said financial difference tree having the same structure as the said financial state trees, but having each of its node's balances be equal to the difference between the balances in the corresponding nodes of the two said financial state trees, the difference being found by subtracting the balance of the node from the financial state tree representing the earlier point in time from the balance of the node from the financial state tree representing the later point in time (for example, the balance in the said financial difference tree's equity node would be found by subtracting the balance of the equity node in the earlier financial state tree from the balance of the equity node in the later financial state tree); said financial difference tree representing the change in the financial state of the enterprise between the time of the said earlier financial state tree and the time of the said later financial state tree.

4. A financial analysis tree software engine as recited by claim 3, where said engine produces a traditional income statement from the difference tree that it has created as recited by claim 3.

5. A financial analysis tree software engine as recited by claim 3, where said engine produces a traditional retained earnings statement from the difference tree that it has created as recited by claim 3.
